(19) United States
(12) Patent Application Publication
(10) Pub. No.: US 2026/0186949 A1
(43) Pub. Date: Jul. 2, 2026

(54) Debugging Program Code in Secure Computing Platform

(71) Applicant: International Business Machines Corporation, Armonk, NY (US)

(72) Inventors: Heng Wang, Beijing (CN); Ying Mo, San Jose, CA (US); Xiao Ling Chen, Beijing (CN); Jing Li, Beijing (CN)

(21) Appl. No.: 19/007,639

(22) Filed: Jan. 2, 2025

(51) Int. Cl. G06F 11/362; G06F 21/57; H04L 9/32

(52) U.S. Cl. CPC G06F 11/362; G06F 21/57; H04L 9/3247

(57) ABSTRACT

A computer-implemented method for debugging microservices within a Trusted Execution Environment (TEE). The TEE receives a debugging script and its corresponding digital signature. The debugging script is digitally signed by a private key to create the digital signature. The TEE verifies the authenticity and integrity of the debugging script by using a public key to validate the digital signature. The TEE executes the debugging script to perform debugging operations on the microservices and generates debugging results. The TEE encrypts the debugging results using the public key and transmits the encrypted debugging results to a logging service for storage.

### BACKGROUND

This disclosure relates generally to debugging program code, and more specifically to debugging program code in a secure computing platform.

As demand for data security and privacy protection continues to grow, secure computing platforms such as, for example, Trusted Execution Environments (TEEs) have become an ideal platform for safeguarding sensitive data and executing security-critical code. A TEE is a secure platform designed to execute code and handle data securely, even in the presence of malicious software on the device. TEEs are considered secure containers because they provide the following features:

Hardware-Based Isolation: The TEE is physically separated from the main execution environment (non-secure) using hardware. This isolation prevents unauthorized access to TEE resources from the main operating system or applications.

Confidentiality and Integrity: Data and code within the TEE are protected from being accessed or tampered with by the normal operating system or applications. Sensitive operations, like cryptographic computations, are performed in the TEE.

Secure Boot and Trusted Code Execution: TEEs ensure that only trusted and verified code is executed within the secure environment, preventing execution of malicious or unverified programs.

Attestation: TEEs support cryptographic attestation, allowing external systems to verify the integrity and trustworthiness of the TEE and its operations.

### SUMMARY

According to an illustrative embodiment, a computer-implemented method for debugging of microservices within a Trusted Execution Environment (TEE) is provided. The TEE receives a debugging script and its corresponding digital signature. The debugging script is digitally signed by a private key to create the digital signature. The TEE verifies the authenticity and integrity of the debugging script by using a public key to validate the digital signature. The public key is installed in the TEE during a bootstrap process. The TEE executes the debugging script to perform debugging operations on the microservices and generates debugging results. The TEE encrypts the debugging results using a public key and transmits the encrypted debugging results to a logging service for storage. The logging service formats the encrypted debugging results. The formatted encrypted debugging results are received from the logging service and the format is removed to extract the encrypted debugging results. The encrypted debugging results are decrypted using the private key to enable inspection of the debugging results. According to other illustrative embodiments, a system and a computer program product for debugging of microservices within a TEE is provided.

### BRIEF DESCRIPTION OF THE DRAWINGS

The novel features believed characteristic of the illustrative embodiments

are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a computing environment in which illustrative embodiments may be implemented;

FIG. 2 illustrates a system in accordance with an illustrative embodiment; and

FIG. 3 depicts a process in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one or more storage media (also called “mediums”) collectively included in a set of one or more storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

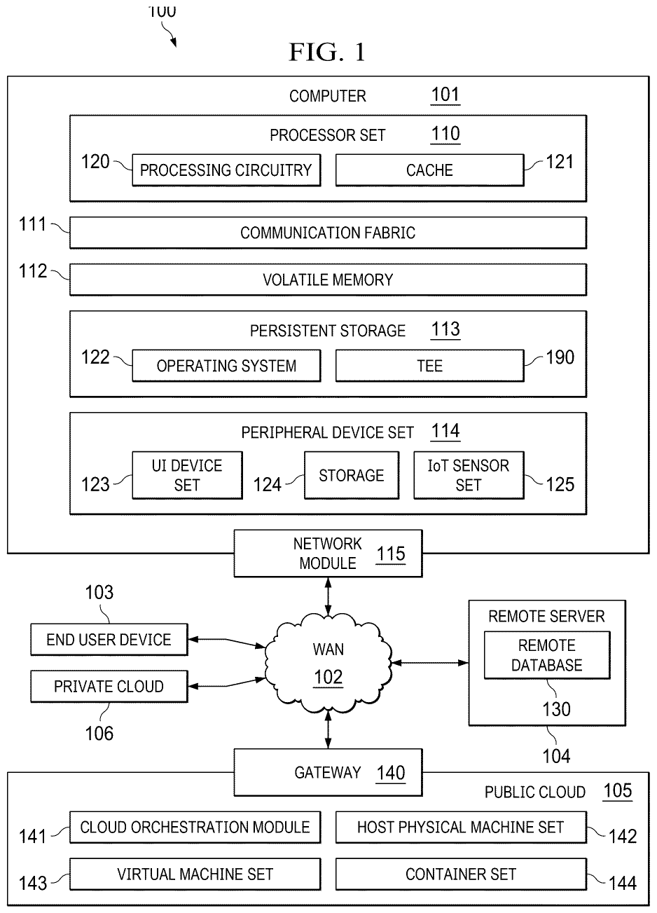

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as trusted execution environment (TEE) 190. In addition to TEE 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and TEE 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods may be stored in TEE 190 in persistent storage 113. In an example embodiment, TEE 190 includes a debugger module (not shown in FIG. 1) which includes some of the instructions for performing the inventive steps.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in TEE 190 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

Cloud Computing Services and/or Microservices: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments address the drawbacks of TEEs by overcoming significant challenges developers face when debugging applications within such secure platforms. While the high-level security of TEEs makes them an ideal platform for secure computation, it also introduces significant challenges for developers. Traditional debugging methods, such as step-by-step execution, memory inspection, and log analysis, rely on accessing the runtime state of an application. The illustrative embodiments mitigate these constraints by introducing mechanisms that enable developers to gain insight into program behavior without compromising the security and integrity of the TEE.

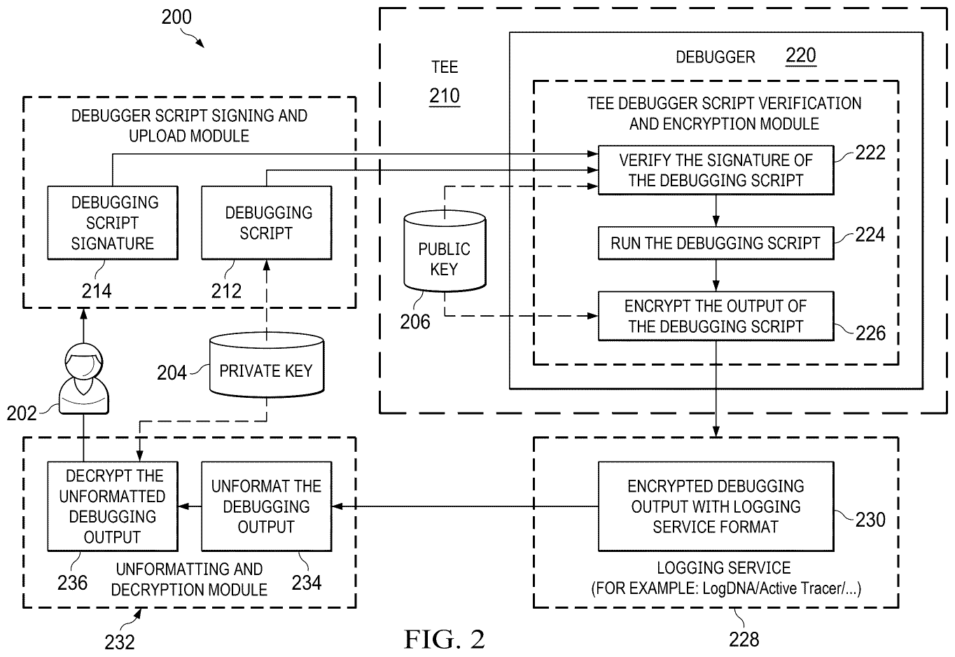

FIG. 2 illustrates system 200 in accordance with an illustrative embodiment. System 200 shows components and data flow for implementing debugging of microservices within a TEE. In the context of system 200, microservices perform specific functions within a larger application. Each microservice can be configured for a single functionality (e.g., debugging, authentication, payment processing, logging) and can communicate with other microservices via, for example, APIs. When deployed in a TEE, microservices benefit from the TEE's isolation, confidentiality, and integrity, and can handle sensitive data (e.g., encryption keys, user credentials, financial transactions) securely within the TEE.

With reference to FIG. 2, user 202 generates a cryptographic key pair comprising private key 204 and public key 206. Private key 204 and public key 206 are part of an asymmetric encryption, where data encrypted with one key can only be decrypted with the other. Private key 204 and public key 204 are mathematically linked but cannot be derived from each other. Several software applications and libraries can be used to facilitate the key generation process. These applications and libraries rely on cryptographic algorithms to generate asymmetric key pairs.

System 200 includes TEE 210, which is a secure computing platform (e.g., secure container) designed to execute code and handle data. User 202 shares public key 206 with TEE 210. For example, public key 206 may be installed or uploaded in TEE 210 during a bootstrap process. Private key 204 is securely stored by user 202 and not shared.

Next, user generates debugging script 212, which is a program or set of commands written to diagnose and identify errors, bugs, or performance bottlenecks in a larger application or system. Debugging scripts can automate tasks such as examining log files, inspecting memory usage, monitoring execution flows, testing specific code paths and print variables. Debugging script 212 can be written in scripting languages like Python, Bash, or PowerShell, depending on system 200.

Next, user 202 signs debugging script 212 and creates digital signature 214. Digital signature 214 is a cryptographic mechanism used to verify the authenticity, integrity, and origin of a digital document (e.g., debugging script 212) or a message. Digital signature 214 ensures that debugging script 212 has not been altered after signing and that digital signature 214 came from the intended signer (e.g., user 202).

In an example embodiment, debugging script 212 is processed using a cryptographic hash function to generate a unique hash value. The hash value is encrypted using the user's private key 204 to create digital signature 214.

Next, debugging script 212 and digital signature 214 are transmitted to TEE 210. In an example embodiment, TEE 210 includes debugger module 220 which verifies digital signature 214 at block 222 using public key 206.

In an example embodiment, debugger module 220 generates a hash of debugging script 212 using the same cryptographic hash function. Debugger module 220 decrypts digital signature 214 using public key 206. The decryption reveals the hash value that was signed by private key 204. Debugger module 220 compares the decrypted hash with the hash of debugging script 212. If the two hashes match, the authenticity and integrity of debugging script 212 is verified. This prevents unauthorized scripts from running in TEE 210.

Next, debugger module 220 executes debugging script at block 224. Debugging script 212 may include instructions for inspecting the behavior of microservices or capturing runtime metrics within TEE 210. After execution, debugger module 220 generates debugging results which may include logs of events, errors or system metrics (e.g., memory usage, CPU usage). The debugging results can be generated in plain text or another readable format.

Next, debugger module 220 encrypts the debugging results using public key 206. Debugger module 220 sends encrypted debugging results 226 to logging service 228. In an example embodiment, logging service 228 is a system or platform designed to collect, store, and manage debugging results, logs or records of events, activities from various applications. Logging service 228 securely stores encrypted debugging results 226, ensuring data confidentiality and protection against unauthorized access. Logging service 228 adds metadata such as timestamps, IP addresses, and other contextual information to the encrypted debugging results and creates logging service formatted results 230.

Next, user 202 uses unformatting and decryption module 232 to retrieve logging service formatted encrypted results 230. Module 232 strips the logging service's formatting from the encrypted results 230 at block 234. User 202 then decrypts the unformatted debugging results at block 236 using private key 204. This ensures that only the authorized user who possesses the private key can access the debugging results. Finally, user 202 reviews the decrypted debugging results.

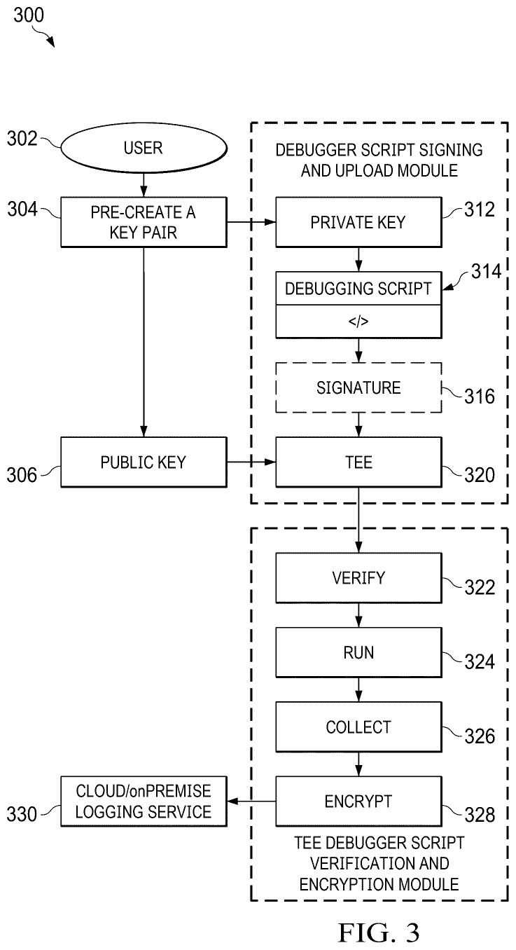

FIG. 3 depicts process 300 in accordance with an illustrative embodiment. Process 300 may be implemented by system 200 shown in FIG. 2.

Initially, user 302 generates a cryptographic key pair at block 304 comprising a private key and a public key. The private key and the public key are part of an asymmetric encryption, where data encrypted with one key can only be decrypted with the other. At block 306, user 302 shares the public key with a TEE. For example, the public key may be installed or uploaded in the TEE during a bootstrap process. The private key securely stored by user 302 and not shared.

At block 312, user 302 signs debugging script 314 using the private key and generates digital signature 316. Digital signature 316 is a cryptographic mechanism used to verify the authenticity, integrity, and origin of a digital document (e.g., debugging script 314) or a message. Digital signature 316 ensures that debugging script 314 has not been altered after signing and that digital signature 316 came from the intended signer (e.g., user 302).

Next, at block 320, debugging script 314 and digital signature 316 are transmitted to the TEE. At block 322, a debugger module within the TEE verifies and authenticates the digital signature using the public key. At block 324, the debugger module executes the debugging script. After execution, at block 326, the debugger module generates debugging results which may include logs of events, errors or system metrics (e.g., memory usage, CPU usage). The debugging results can be generated in plain text or another readable format. At block 328, the debugger module encrypts the debugging results, and at block 330, the debugger module sends the encrypted debugging results to a logging service. In an example embodiment, the logging service is a system or platform designed to collect, store, and manage debugging results, logs or records of events, activities from various applications. The logging service adds metadata such as timestamps, IP addresses, and other contextual information to the encrypted debugging results and creates logging service formatted results.

As used herein, a first component “connected to” a second component means that the first component can be connected directly or indirectly to the second component. In other words, additional components may be present between the first component and the second component. The first component is considered to be indirectly connected to the second component when one or more additional components are present between the two components. When the first component is directly connected to the second component, no additional components are present between the two components.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method for debugging of microservices within a Trusted Execution Environment (TEE), the method comprising:
receiving a debugging script and its corresponding digital signature, wherein the debugging script is digitally signed by a private key to create the digital signature;
verifying, within the TEE, an authenticity and integrity of the debugging script by using a public key to validate the digital signature;
executing the debugging script within the TEE to perform debugging operations on the microservices and generating debugging results;
encrypting the debugging results using the public key within the TEE; and
transmitting the encrypted debugging results to a logging service for storage.

2. The computer-implemented method of claim 1, further comprising:
receiving logging service formatted debugging results from the logging service;
removing a format of the logging service to extract the encrypted debugging results; and
decrypting the encrypted debugging results using the private key to enable inspection of the debugging results.

3. The computer-implemented method of claim 1, wherein the public key is installed in the TEE during a bootstrap process.

4. The computer-implemented method of claim 1, wherein the logging service is a cloud-based or on-premise system configured to securely store the encrypted debugging results.

5. The computer-implemented method of claim 1 wherein the logging service adds metadata and contextual information to the encrypted debugging results.

6. The computer-implemented method of claim 1, wherein the TEE is a secure area of a computing environment configured to execute code and handle data securely.

7. A computer-implemented method for debugging in a Trusted Execution Environment (TEE), the method comprising:
generating a cryptographic key pair comprising a private key and a public key;
installing the public key into the TEE during its bootstrap process;
creating a debugging script;
digitally signing the debugging script using the private key and generating a digital signature; and
uploading the debugging script and the digital signature to the TEE.

8. The computer-implemented method of claim 7, further comprising:
receiving formatted encrypted debugging results from a logging service;
removing a format of the logging service to extract the encrypted debugging results; and
decrypting the encrypted debugging results using the private key to enable inspection of the debugging results.

9. The computer-implemented method of claim 7, wherein the TEE is a secure area of a computing environment configured to execute code and handle data securely.

10. A computer system comprising:
a processor set;
one or more computer-readable storage media; and
program instructions stored on the one or more computer-readable storage media to cause the processor set to perform operations comprising:
receiving, by a Trusted Execution Environment (TEE), a debugging script and its corresponding digital signature, wherein the debugging script is digitally signed by a private key to create the digital signature;
verifying, within the TEE, an authenticity and integrity of the debugging script by using a public key to validate the digital signature;
executing the debugging script within the TEE to perform debugging operations and generating debugging results;
encrypting the debugging results using the public key within the TEE; and
transmitting the encrypted debugging results to a logging service for storage.

11. The computer system of claim 10, wherein the operations further comprise:
receiving formatted encrypted debugging results from the logging service;
removing a format of the logging service to extract the encrypted debugging results; and
decrypting the encrypted debugging results using the private key to enable inspection of the debugging results.

12. The computer system of claim 10, wherein the TEE is a secure area of a computing environment configured to execute code and handle data securely.

13. The computer system of claim 10, wherein the operations further comprise adding metadata to the encrypted debugging results by the logging service.

14. A computer program product comprising:
one or more computer-readable storage media;
program instructions stored on the one or more storage media to perform operations comprising:
receiving, at a Trusted Execution Environment (TEE), a debugging script and its corresponding digital signature, wherein the debugging script is digitally signed by a private key to create the digital signature;
verifying, within the TEE, an authenticity and integrity of the debugging script by using a public key to validate the digital signature;
executing the debugging script within the TEE to perform debugging operations on microservices and generating debugging results;
encrypting the debugging results using the public key within the TEE; and
transmitting the encrypted debugging results to a logging service for storage.

15. The computer program product of claim 14, wherein the operations further comprise:
receiving logging service formatted debugging results from the logging service;
removing a format of the logging service to extract the encrypted debugging results; and
decrypting the encrypted debugging results using the private key to enable inspection of the debugging results.

16. The computer program product of claim 14, wherein the public key is installed in the TEE during a bootstrap process.

17. The computer program product of claim 14, wherein the logging service is a cloud-based or on-premise system configured to securely store the encrypted debugging results.

18. The computer program product of claim 14 wherein the logging service adds metadata and contextual information to the encrypted debugging results.

19. The computer program product of claim 14, wherein the TEE is a secure area of a computing environment configured to execute code and handle data securely.

20. The computer program product of claim 14, wherein the operations further comprise installing the public key into the TEE during its bootstrap process.
